(19) United States
(12) Patent Application Publication
(10) Pub. No.: US 2026/0171070 A1
(43) Pub. Date: Jun. 18, 2026

(54) SYSTEMS AND METHODS FOR SPEECH GENERATION USING LATENT FEATURES EXTRACTED FROM INTERMEDIATE LAYERS OF AN ACOUSTIC MODEL

(71) Applicants: Constructor Technology AG, Schaffhausen (CH); Constructor Education and Research Genossenschaft, Schaffhausen (CH)

(72) Inventors: Sergey ULASEN, Singapore (SG); Andrey ADASHCIK, Istanbul (TR); Dmitrii OBUKHOV, Castelló de la Plana (ES); Marcel de KORTE, Stockholm (SE); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 18/982,088

(22) Filed: Dec. 16, 2024

(51) Int. Cl. G10L 13/027; G06N 3/084; G10L 13/047; G10L 13/06

(52) U.S. Cl. CPC G10L 13/027; G10L 13/047; G10L 13/06; G06N 3/084

(57) ABSTRACT

Disclosed herein are systems and methods for training a text-to-speech machine learning model. A method includes: inputting training text into an acoustic model configured to generate an intermediate representation including predicted latent features for a vocoder model that further generates a waveform of speech reciting the training text; inputting a target waveform into a self-supervising learning (SSL) model configured to generate a vector representation of the target waveform, wherein the target waveform is true speech reciting the training text; extracting and summing SSL features from a plurality of layers of the SSL model; computing a loss between a sum of the SSL features from the SSL model and the predicted latent features from the acoustic model; updating, using backpropagation, weights of the acoustic model based on the loss; and executing the acoustic model with the updated weights on a test text to generate the intermediate representation.

### FIELD OF TECHNOLOGY

The present disclosure relates to the field of text-to-speech conversion, and, more specifically, to systems and methods for speech generation using latent features extracted from intermediate layers of an acoustic model.

### BACKGROUND

Traditional text-to-speech pipelines typically employ Mel spectrogram features as an intermediate representation between an acoustic model and a vocoder. However, Mel spectrograms or related features compress information in such a way that it causes the loss of some important acoustic knowledge. In addition, the lower regions of Mel spectrograms can be quite different from speaker to speaker. This makes these speech representations suboptimal in a voice-cloning setting, where one wishes to produce high-quality speech with limited resources.

### SUMMARY

The present disclosure describes applying self-supervised learning (SSL) features from a speech model as the intermediate representation. Unlike other approaches that usually extract a speech representation from the final layer of the speech model, the systems and methods of the present disclosure extract latent features from multiple layers of the SSL model. Because different layers encode different sorts of information, by summing the representations from layers at different depths of the speech model, a representation that encapsulates linguistic, acoustic, and speaker-specific information is acquired-resulting in better speech generation.

In one exemplary aspect, the techniques described herein relate to a method for training a text-to-speech machine learning model, the method including: inputting training text into an acoustic model configured to generate an intermediate representation including predicted latent features for a vocoder model that further generates a waveform of speech reciting the training text; inputting a target waveform into a self-supervising learning (SSL) model configured to generate a vector representation of the target waveform, wherein the target waveform is true speech reciting the training text; extracting and summing SSL features from a plurality of layers of the SSL model; computing a loss between a sum of the SSL features from the SSL model and the predicted latent features from the acoustic model; updating, using backpropagation, weights of the acoustic model based on the loss; and executing the acoustic model with the updated weights on a test text to generate the intermediate representation.

In some aspects, the techniques described herein relate to a method, further including: subsequent to updating the weights of the acoustic model, receiving re-predicted latent features from the acoustic model; computing another loss between the sum of the SSL features and the re-predicted latent features; and updating, using backpropagation, the weights of the acoustic model until the another loss is less than a threshold loss or a maximum number of iterations has been reached.

In some aspects, the techniques described herein relate to a method, further including: subsequent to updating the weights of the acoustic model, receiving re-predicted latent features from the acoustic model; inputting the re-predicted latent features into the vocoder model to receive an output waveform; determining a difference between the output waveform and the target waveform; updating, using backpropagation, weights of the vocoder model based on the difference; and executing the vocoder model with the updated weights on the intermediate representation associated with the test text to generate a test waveform of speech reciting the test text.

In some aspects, the techniques described herein relate to a method, wherein the plurality of layers includes at least one intermediate layer and a final layer of the SSL model.

In some aspects, the techniques described herein relate to a method, further including: selecting the at least one intermediate layer of the SSL model based on a type of data outputted by the at least one intermediate layer, wherein latent features corresponding to the type of data are to be summed.

In some aspects, the techniques described herein relate to a method, further including: selecting the at least one intermediate layer of the SSL model based on a position of the at least one intermediate layer, wherein latent features from pre-determined positions in the acoustic model are to be summed.

In some aspects, the techniques described herein relate to a method, wherein every third layer is included in the at least one intermediate layer of the SSL model.

In some aspects, the techniques described herein relate to a method, wherein the input text is converted into a phoneme sequence.

It should be noted that the methods described above may be implemented in a system comprising a hardware processor. Alternatively, the methods may be implemented using computer executable instructions of a non-transitory computer readable medium.

In some aspects, the techniques described herein relate to a system for training a text-to-speech machine learning model, including: at least one memory; and at least one hardware processor coupled with the at least one memory and configured, individually or in combination, to: input training text into an acoustic model configured to generate an intermediate representation including predicted latent features for a vocoder model that further generates a waveform of speech reciting the training text; input a target waveform into a self-supervising learning (SSL) model configured to generate a vector representation of the target waveform, wherein the target waveform is true speech reciting the training text; extract and sum SSL features from a plurality of layers of the SSL model; compute a loss between a sum of the SSL features from the SSL model and the predicted latent features from the acoustic model; update, using backpropagation, weights of the acoustic model based on the loss; and execute the acoustic model with the updated weights on a test text to generate the intermediate representation.

In some aspects, the techniques described herein relate to a non-transitory computer readable medium storing thereon computer executable instructions for training a text-to-speech machine learning model, including instructions for: inputting training text into an acoustic model configured to generate an intermediate representation including predicted latent features for a vocoder model that further generates a waveform of speech reciting the training text; inputting a target waveform into a self-supervising learning (SSL) model configured to generate a vector representation of the target waveform, wherein the target waveform is true speech reciting the training text; extracting and summing SSL features from a plurality of layers of the SSL model; computing a loss between a sum of the SSL features from the SSL model and the predicted latent features from the acoustic model; updating, using backpropagation, weights of the acoustic model based on the loss; and executing the acoustic model with the updated weights on a test text to generate the intermediate representation.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for training a text-to-speech model using latent features extracted from intermediate layers of an acoustic model.

FIG. 2 is a block diagram illustrating a system for executing a text-to-speech model using latent features extracted from intermediate layers of an acoustic model.

FIG. 3 illustrates a flow diagram of a method for speech generation using latent features extracted from intermediate layers of an acoustic model.

FIG. 4 presents an example of a general-purpose computer system on which aspects of the present disclosure can be implemented.

### DETAILED DESCRIPTION

Exemplary aspects are described herein in the context of a system, method, and computer program product for speech generation using latent features extracted from intermediate layers of an acoustic model. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

As discussed before, a conventional approach to training text-to-speech machine learning models involves generating, using an acoustic model, a Mel spectrogram, which is subsequently used by a vocoder model to generate audio. A Mel spectrogram is a visual representation of the spectrum of frequencies in a sound signal as they vary with time, using the Mel scale. The Mel scale is a perceptual scale of pitches judged by listeners to be equal in distance from one another. It is designed to approximate the human ear's response more closely than the linearly spaced frequency bands used in a standard spectrogram. The x-axis of a Mel spectrogram represents the progression of time and is typically measured in seconds or milliseconds. The y-axis represents the frequency components of the signal according to the Mel scale. The color or brightness in a Mel spectrogram represents the amplitude or intensity of the frequencies at each point in time and is often depicted using a color gradient, where different colors or shades represent different intensity levels.

While Mel spectrograms offer a perceptually relevant representation of audio signals, their use in vocoders comes with several challenges. These include the loss of phase information, resolution trade-offs, computational complexity, potential artifacts, limited temporal resolution, dependency on windowing parameters, non-linear transformation issues, and training data dependency.

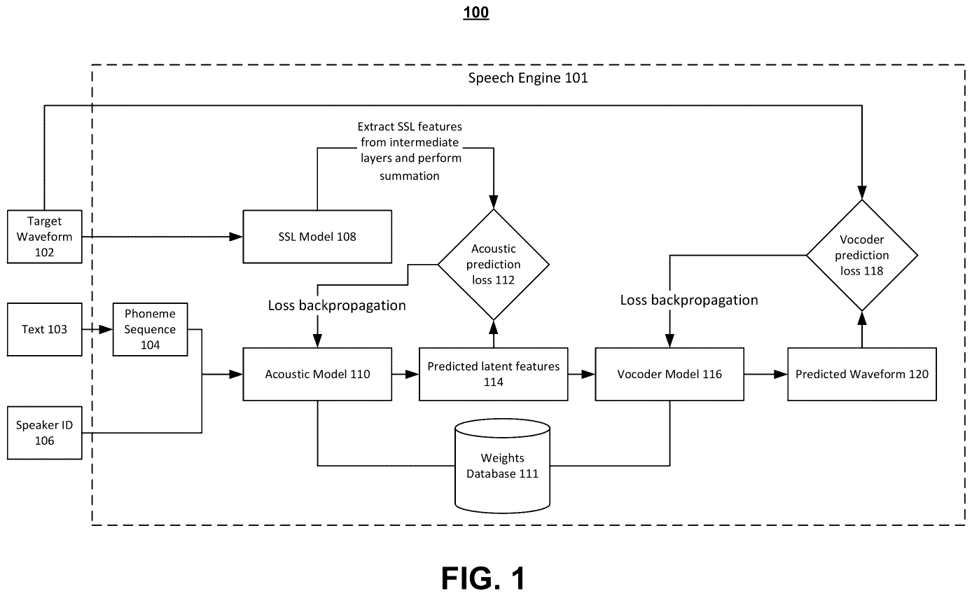

The systems and methods of the present disclosure overcome these issues by extracting additional information from intermediate layers of a self-supervised learning (SSL) model when training an acoustic model. FIG. 1 depicts a system 100 for training a text-to-speech model using said intermediate layers of an SSL model.

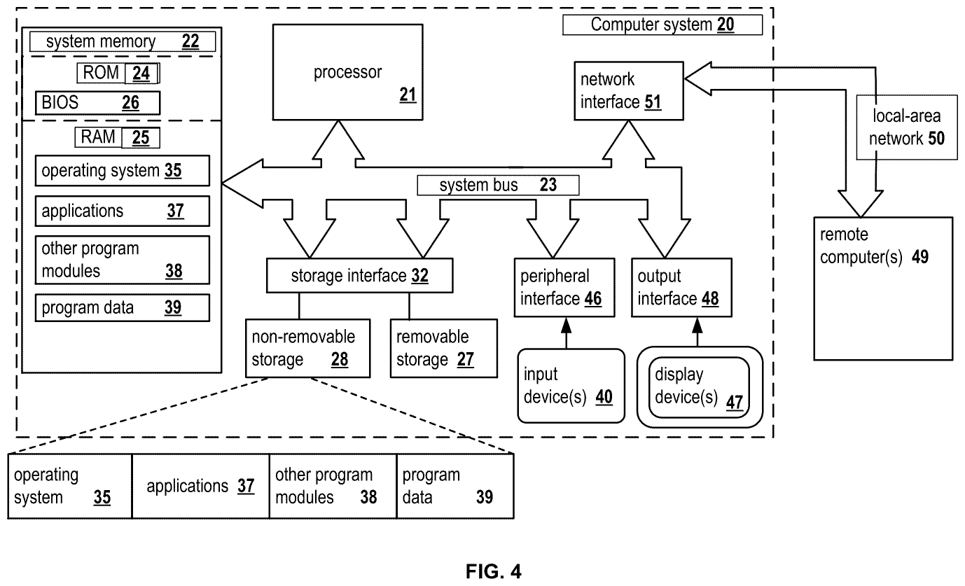

System 100 includes speech engine 101, which may be a software module executed by computer system 20 (described in FIG. 4). Firstly, a target waveform 102 and a text 103 are provided as a training input. As a part of pre-processing, text 103 may be converted by speech engine 101 into phoneme sequence 104. In some aspects, a speaker ID 106 indicating an attribute (e.g., name, identification card number, employee number, initials, etc.) of the person speaking in target waveform 102 is also provided to speech engine 101.

Within speech engine 101, SSL model 108 (e.g., Wav2Vec2 model) receives target waveform 102. SSL features are extracted from certain intermediate layers of the model 108 and summed together. These SSL features are associated with the target waveform 102. In order to reproduce target waveform 102, acoustic model 110 generates predicted latent features 114. A difference between predicted latent features 114 and the summed SSL features output by SSL model 108 is determined. Acoustic prediction loss 112 (i.e., the difference) is then used in backpropagation, which involves computing the gradients of the loss function with respect to the acoustic model 110's parameters and updating these parameters to minimize the loss 112. This process enables acoustic model 110 to learn from the training data and improve its performance.

The predicted latent features 114 when loss 112 is minimized (e.g., below a threshold value) is entered into a vocoder model 116, which generates a predicted waveform 120. Predicted waveform 120 is compared to target waveform 102 and vocoder prediction loss 118 is calculated. Loss 118 is used in backpropagation to improve the performance of vocoder model 116 such that the difference in the target waveform 102 and predicted waveform 120 is minimized when given predicted latent features 114 as an input.

It should be noted that different layers in SSL model 108 have different purposes. These layers work together to process the raw audio signal, extract meaningful features, and produce a representation that can be used for various downstream tasks. Here are some example layers that are in SSL model 108:

### 1. Input Layer:

Purpose: To receive the raw audio waveform.
Example: A 1D convolutional layer that takes the raw audio signal as input.

### 2. Feature Extraction Layers:

Purpose: To extract low-level features from the raw audio waveform.
Example Layers:
1D Convolutional Layers: These layers apply convolution operations along the time axis to capture local temporal patterns in the audio signal.
Activation Functions: Non-linear functions like ReLU (Rectified Linear Unit) are applied after convolutional layers to introduce non-linearity.
Batch Normalization: Normalizes the output of the convolutional layers to stabilize and accelerate training.

### 3. Pooling Layers:

Purpose: To reduce the temporal resolution of the feature maps and make the representations more compact.
Example Layers:
Max Pooling: Selects the maximum value in each pooling window.
Average Pooling: Computes the average value in each pooling window.

### 4. Intermediate Representation Layers:

Purpose: To transform the extracted features into a higher-level representation that captures more complex patterns and dependencies.
Example Layers:
Transformer Layers: These layers use self-attention mechanisms to capture long-range dependencies and contextual information in the audio signal.
Recurrent Layers: Layers like LSTM (Long Short-Term Memory) or GRU (Gated Recurrent Unit) can be used to capture temporal dependencies.
Feed-Forward Layers: Fully connected layers that further process the features extracted by convolutional or recurrent layers.

### 5. Contextualization Layers:

Purpose: To incorporate contextual information from the entire input sequence.
Example Layers:
Multi-Head Self-Attention: Used in transformer layers to allow the model to focus on different parts of the input sequence simultaneously.
Positional Encoding: Adds information about the position of each element in the sequence, which is crucial for models like transformers that do not inherently capture sequence order.

### 6. Normalization Layers:

Purpose: To stabilize and improve the training process.
Example Layers:
Layer Normalization: Normalizes the output of each layer to have a mean of zero and a variance of one.
Batch Normalization: Normalizes the output of the previous activation layer to improve training stability.

### 7. Output Layer:

Purpose: To produce the final intermediate representation.
Example Layers:
Linear Layer: A fully connected layer that maps the high-level features to the desired output dimension.
Softmax or Sigmoid (if needed): Applied to the output for specific tasks, though not typically used for intermediate representations.

The SSL features extracted from various layers may be based on an importance of a layer. For example, certain transformer layers may use self-attention mechanisms to capture long-range dependencies and contextual information in the audio signal. The output of such layers may be selected to include in the summation of SSL features.

In some aspects, the selection of layers to extract information from is based on layer position. Suppose that SSL model 108 has is a 12-layer transformer model. In some aspects, every third layer is automatically selected and features are extracted from said layers. By summing the representations from layers at different depths of the network, a powerful representation that encapsulates linguistic, acoustic, and speaker specific information is created.

In some aspects, acoustic model 110 includes several layers designed to process the phoneme sequence 104 and generate a suitable representation for audio synthesis by vocoder model 116. Here are some example layers that are in acoustic model 110:

### 1. Input Embedding Layer:

Purpose: To convert the discrete phoneme sequence into continuous embeddings.
Example Layers:
   Embedding Layer: Maps each phoneme to a dense vector representation.

### 2. Positional Encoding (if Using Transformers):

Purpose: To add information about the position of each phoneme in the sequence.
Example Layers:
   Positional Encoding: Adds positional information to the embeddings.

### 3. Sequence Processing Layers:

Purpose: To capture the temporal dependencies and contextual information from the phoneme sequence.
Example Layers:
   Recurrent Layers: LSTM or GRU layers to capture sequential dependencies.
   Transformer Layers: Self-attention layers to capture long-range dependencies.

### 4. Intermediate Representation Layers:

Purpose: To transform the processed sequence into a suitable representation for the vocoder.
Example Layers:
   Fully Connected Layers: Dense layers to map the sequence to the desired intermediate representation.

### 5. Prosody Prediction Layers:

Purpose: To predict pitch and energy values in audio and phoneme durations
Example Layers:
   1D Convolutional Layers: Convolution operations along the time axis to capture local temporal patterns
   Transformer Layers: Self-attention layers to capture long-range dependencies.

### 6. Normalization Layers:

Purpose: To stabilize and improve the training process.
Example Layers:
   Layer Normalization: Normalizes the output of each layer.

### 7. Output Layer:

Purpose: To produce the final intermediate representation for the vocoder.
Example Layers:
   Linear Layer: Maps the processed sequence to the final representation.

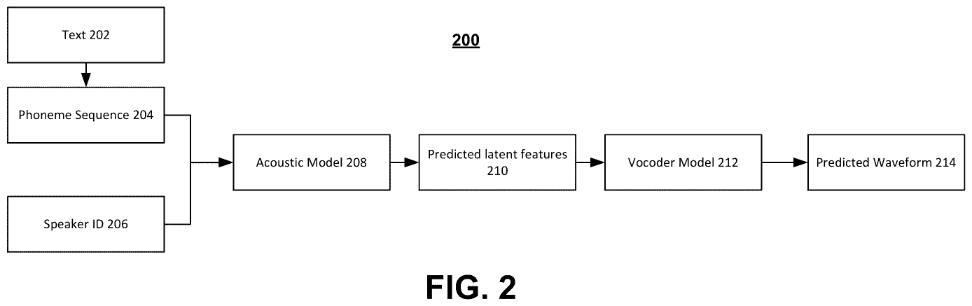

FIG. 2 depicts a system 200 for executing a trained text-to-speech

model using features extracted from intermediate layers of an acoustic model. In system 200, text 202 is converted to phoneme sequence 204. Speaker ID 206 indicates the voice profile to use when generating the output waveform. Using speaker ID 206 the relevant weights learned by acoustic model 208 and vocoder model 212 are initiated. In other words, if a different speaker ID is provided as an input, a different set of learned weights are loaded for use by acoustic model 208 and vocoder model 212. All learned weights may be stored in weights database 111 that maps weights to a plurality of speaker IDs.

Acoustic model 208 receives phoneme sequence 204 and generates predicted latent features 210. Features 210 are input into trained vocoder model 212, which generates predicted waveform 214.

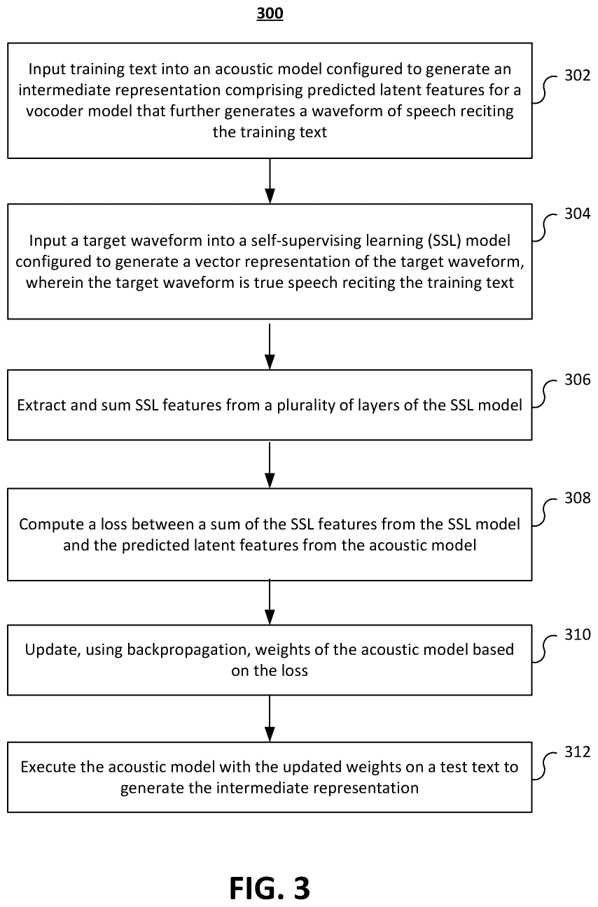

FIG. 3 illustrates a flow diagram of method 300 for speech generation using latent features extracted from intermediate layers of an acoustic model. At 302, speech engine 101 inputs training text 103 into an acoustic model 110 configured to generate an intermediate representation comprising predicted latent features 114 for a vocoder model 116. Predicted latent features 114 are a vector representation of the phonetic and prosodic characteristics of the text 103. The vocoder model 116 may be further configured to generate a waveform 120 of speech reciting the training text. In some aspects, the input text 103 is converted into a phoneme sequence 104.

At 304, speech engine 101 inputs a target waveform 102 into a self-supervising learning (SSL) model 108 configured to generate a vector representation of the target waveform 102 (e.g., a high-dimensional vector capturing the acoustic features of the speech). In this case, the target waveform 102 is a true speech reciting the training text in the manner that it is supposed to be recited. For example, if the text is “tomorrow is a brand new day,” target waveform 102 may be a recorded waveform of someone saying “tomorrow is a brand new day.”

At 306, speech engine 101 extracts and sums SSL features from a plurality of layers of the SSL model. For example, speech engine 101 may extract features from the third layer, the sixth layer, the ninth layer, etc., and sum the features into a single vector that combines information from multiple layers). In some aspects, the plurality of layers comprises at least one intermediate layer and a final layer of the SSL model.

SSL models are designed to learn representations of data without requiring labeled examples. In the context of speech processing, SSL models like Wav2Vec 2.0, HuBERT, or others are trained to understand and represent the acoustic properties of speech by predicting parts of the input data from other parts.

SSL models typically consist of multiple layers, each capturing different levels of abstraction and features from the input data. For instance, lower layers may capture basic acoustic features such as phonemes or short-time spectral properties, middle layers may capture more complex patterns like syllables or prosodic features, and higher layers may capture even more abstract representations such as speaker characteristics or semantic content. To leverage the information captured at different levels of abstraction, speech engine 101 extracts features from multiple layers of the SSL model. This may lead to the combination of low-level acoustic details with high-level abstract features, leading to a more comprehensive representation.

In some aspects, speech engine 101 may select the at least one intermediate layer of the SSL model based on a position of the at least one intermediate layer. In this case, the latent features from pre-determined positions in the acoustic model are to be summed. For example, every third layer may be selected by speech engine 101 (i.e., is comprised in the at least one intermediate layer of the SSL model).

In some aspects, speech engine 101 may select the at least one intermediate layer of the SSL model based on a type of data outputted by the at least one intermediate layer. The latent features corresponding to the type of data are to be summed. For example, as previously mentioned, the lower levels may output data pertaining to phonemes or short-time spectral properties. This type of data may be the sole focus when combining layers (e.g., sum all features from layers 1-3). In a simplistic example, suppose that the layer outputs are as follows:
Layer 1:[0.1, 0.2, 0.3]
Layer 2:[0.4, 0.5, 0.6]
Layer 3:[0.7, 0.8, 0.9]

The summed features may be given by: [0.1, 0.2, 0.3]+[0.4, 0.5, 0.6]+[0.7, 0.8, 0.9]=[1.2, 1.5, 1.8].

At 308, speech engine 101 computes a loss (e.g., acoustic prediction loss 112) between a sum of the SSL features from the SSL model and the predicted latent features 114 from the acoustic model 110. In some aspects, the loss is determined using mean squared error.

At 310, speech engine 101 updates, using backpropagation, weights of the acoustic model 110 based on the loss. In some aspects, speech engine 101 stores these weights in weights database 111 and maps said weights to speaker ID 106 for future use.

In some aspects, subsequent to updating the weights of the acoustic model 110, speech engine 101 receives re-predicted latent features from the acoustic model 110. Speech engine 101 may then compute another loss between the sum of the SSL features and the re-predicted latent features. Speech engine 101 may then update, using backpropagation, the weights of the acoustic model again. This loop of updating the weights may repeat until the latest calculated loss is less than a threshold loss or a maximum number of iterations (preset) is reached. In each loop, the weights in weights database 111 may be updated to the latest updated weights.

Consider an example in which the latent features are [0.4, 0.65, 0.75] and the target features are [0.5, 0.6, 0.7]. In this case, the loss is 0.005 (using mean squared error). If the threshold is 0.01, then the calculated loss meets the criteria of training, and the training is ended.

At 312, speech engine 101 executes the acoustic model 110 with the updated weights on a test text 202 to generate the intermediate representation (e.g., predicted latent features 210).

In some aspects, subsequent to updating the weights of the acoustic model 110, speech engine 101 receives re-predicted latent features from the acoustic model 110. Speech engine 101 may then input the re-predicted latent features into the vocoder model 116 to receive an output waveform 120. Speech engine 101 may determine a difference between the output waveform 120 and the target waveform 102, and accordingly update, using backpropagation, weights of the vocoder model 116 based on the difference. These weights may also be stored in weights database 111. Once the vocoder model 116 has also been trained (e.g., the difference has been minimized below a threshold loss), speech engine 101 may execute the vocoder model 116 with the updated weights on the intermediate representation (e.g., predicted latent features 210) associated with the test text 202 to generate a test waveform (e.g., predicted waveform 214) of speech reciting the test text 202.

FIG. 4 is a block diagram illustrating a computer system 20 on which aspects of systems and methods for speech generation using latent features extracted from intermediate layers of an acoustic model may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-3 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for training a text-to-speech machine learning model, the method comprising:
inputting training text into an acoustic model configured to generate an intermediate representation comprising predicted latent features for a vocoder model that further generates a waveform of speech reciting the training text;
inputting a target waveform into a self-supervising learning (SSL) model configured to generate a vector representation of the target waveform, wherein the target waveform is true speech reciting the training text;
extracting and summing SSL features from a plurality of layers of the SSL model;
computing a loss between a sum of the SSL features from the SSL model and the predicted latent features from the acoustic model;
updating, using backpropagation, weights of the acoustic model based on the loss; and
executing the acoustic model with the updated weights on a test text to generate the intermediate representation.

2. The method of claim 1, further comprising:
subsequent to updating the weights of the acoustic model, receiving re-predicted latent features from the acoustic model;
computing another loss between the sum of the SSL features and the re-predicted latent features; and
updating, using backpropagation, the weights of the acoustic model until the another loss is less than a threshold loss or a maximum number of iterations has been reached.

3. The method of claim 1, further comprising:
subsequent to updating the weights of the acoustic model, receiving re-predicted latent features from the acoustic model;
inputting the re-predicted latent features into the vocoder model to receive an output waveform;
determining a difference between the output waveform and the target waveform;
updating, using backpropagation, weights of the vocoder model based on the difference until the difference is less than a threshold difference or a maximum number of iterations has been reached; and
executing the vocoder model with the updated weights on the intermediate representation associated with the test text to generate a test waveform of speech reciting the test text.

4. The method of claim 1, wherein the plurality of layers comprises at least one intermediate layer and a final layer of the SSL model.

5. The method of claim 4, further comprising:
selecting the at least one intermediate layer of the SSL model based on a type of data outputted by the at least one intermediate layer, wherein latent features corresponding to the type of data are to be summed.

6. The method of claim 4, further comprising:
selecting the at least one intermediate layer of the SSL model based on a position of the at least one intermediate layer, wherein latent features from pre-determined positions in the acoustic model are to be summed.

7. The method of claim 6, wherein every third layer is comprised in the at least one intermediate layer of the SSL model.

8. The method of claim 1, wherein the input text is converted into a phoneme sequence.

9. A system for training a text-to-speech machine learning model, comprising:
at least one memory; and
at least one hardware processor coupled with the at least one memory and configured, individually or in combination, to:
input training text into an acoustic model configured to generate an intermediate representation comprising predicted latent features for a vocoder model that further generates a waveform of speech reciting the training text;
input a target waveform into a self-supervising learning (SSL) model configured to generate a vector representation of the target waveform, wherein the target waveform is true speech reciting the training text;
extract and sum SSL features from a plurality of layers of the SSL model;
compute a loss between a sum of the SSL features from the SSL model and the predicted latent features from the acoustic model;
update, using backpropagation, weights of the acoustic model based on the loss; and
execute the acoustic model with the updated weights on a test text to generate the intermediate representation.

10. The system of claim 9, wherein the at least one hardware processor is configured to:
subsequent to updating the weights of the acoustic model, receive re-predicted latent features from the acoustic model;
compute another loss between the sum of the SSL features and a sum of the re-predicted latent features; and
update, using backpropagation, the weights of the acoustic model until the another loss is less than a threshold loss or a maximum number of iterations has been reached.

11. The system of claim 9, wherein the at least one hardware processor is configured to:
subsequent to updating the weights of the acoustic model, receive re-predicted latent features from the acoustic model;
input the re-predicted latent features into the vocoder model to receive an output waveform;
determine a difference between the output waveform and the target waveform;
update, using backpropagation, weights of the vocoder model based on the difference until the difference is less than a threshold difference or a maximum number of iterations has been reached; and
execute the vocoder model with the updated weights on the intermediate representation associated with the test text to generate a test waveform of speech reciting the test text.

12. The system of claim 9, wherein the plurality of layers comprises at least one intermediate layer and a final layer of the SSL model.

13. The system of claim 12, wherein the at least one hardware processor is configured to:
select the at least one intermediate layer of the SSL model based on a type of data outputted by the at least one intermediate layer, wherein latent features corresponding to the type of data are to be summed.

14. The system of claim 12, wherein the at least one hardware processor is configured to:
select the at least one intermediate layer of the SSL model based on a position of the at least one intermediate layer, wherein latent features from pre-determined positions in the acoustic model are to be summed.

15. The system of claim 14, wherein every third layer is comprised in the at least one intermediate layer of the SSL model.

16. The system of claim 9, wherein the input text is converted into a phoneme sequence.

17. A non-transitory computer readable medium storing thereon computer executable instructions for training a text-to-speech machine learning model, including instructions for:
inputting training text into an acoustic model configured to generate an intermediate representation comprising predicted latent features for a vocoder model that further generates a waveform of speech reciting the training text;
inputting a target waveform into a self-supervising learning (SSL) model configured to generate a vector representation of the target waveform, wherein the target waveform is true speech reciting the training text;
extracting and summing SSL features from a plurality of layers of the SSL model;
computing a loss between a sum of the SSL features from the SSL model and the predicted latent features from the acoustic model;
updating, using backpropagation, weights of the acoustic model based on the loss; and
executing the acoustic model with the updated weights on a test text to generate the intermediate representation.
